(19) United States
(12) Patent Application Publication
(10) Pub. No.: US 2020/0195192 A1
(43) Pub. Date: Jun. 18, 2020

(54) Integrated Tilting Solar Tracker

(71) Applicant: Radhakrishnan SK, Coimbatore (IN)

(72) Inventor: Radhakrishnan SK, Coimbatore (IN)

(21) Appl. No.: 16/484,429

(22) PCT Filed: Jun. 7, 2019
(86) PCT No.: PCT/IB2019/054758

§ 371 Date: Aug. 7, 2019

(30) Foreign Application Priority Data
Aug. 28, 2018 (IN) 201841031705

(51) Int. Cl. H02S 20/32; F24S 30/455; F24S 50/80; F24S 25/20; H02S 30/10; F16M 11/10; F16M 11/20; F16M 11/22

(52) U.S. Cl. CPC H02S 20/32; F24S 30/455; F24S 50/80; F24S 25/20; F24S 2030/11; F16M 11/10; F16M 11/2021; F16M 11/22; H02S 30/10

(57) ABSTRACT

The invention relates to an innovative, highly productive, modular construction, integrated tilting, fully automatic, location specific and economically viable ‘Integrated Tilting Solar Tracker (ITST)’ apparatus with unique integrated tilting arrangement for tilting the solar photovoltaic (SPV) panels simultaneously in the ‘East-West’ and ‘North-South’ directions in an ‘integrated manner’, in order to maintain the surface of the solar cells affixed over the solar photovoltaic panels, receive the sun's light rays perpendicularly during most period of the day time (sunny time) of a day and every day in a year, matching the dynamic and varying 3-dimensional movements of the sun with respect to the location of the ‘Integrated Tilting Solar Tracker (ITST)’ on earth, to generate maximum solar energy resulting in the highest productivity.

This Application claims priority from a complete patent application filed in India having Patent Application No. 201841031705, filed on Aug. 24, 2018 and titled “INTEGRATED TILTING SOLAR TRACKER”.

### DESCRIPTION

### Field of Art

This invention relates to the field of solar energy, and more particularly to a solar tracker to increase the productivity of solar power generation. The invention is particularly concerned with the novelty of the ‘Integrated Tilting Solar Tracker (ITST)’ apparatus designed to deliver the highest productivity.

### Background of the Art

Solar tracker is an apparatus constructed with necessary structural assembly arrangement with suitable drive sources to orient the plurality of the solar photovoltaic panels mounted on the said apparatus enable to face the sun's position in order to maintain the surface of the solar cells affixed over the solar photovoltaic panels, receive the sun's light rays perpendicularly during most period of the day time (sunny time) of a day and every day in a year to harvest maximum energy.

There are different types of solar trackers are available in the market.

The single axis trackers are built to dynamically orient the solar photovoltaic panels' to cover only the East-West motion of the sun, on a daily basis. Since single axis tracking has the limited tracking potential (because, it follows only one direction motion of the sun), the increase in the productivity due to this single axis tracking is also limited. Apart from the disadvantage of the limited productivity increase, the single axis trackers are normally built and available in mass structure (single axis trackers are normally built clustered in bulk single capacity of 250 kW or the like) only, which not only calls for high cost but also demands additional civil construction, well levelled land and more space for installation—which again increases the cost, resulting in, single axis trackers are no more viable at the present prevailing cost of the solar power plant. The mass structure construction of the single axis tracker also demands high maintenance cost resulting in increase of the running cost. The additional financial benefit generated due to the increase in the productivity achievable owing to the deployment of the single axis tracker is not commensurate to the additional cost deployed to install the single axis tracker. This cost benefit analysis, is all the more important, since the cost of the solar power projects has fallen down sharply from the year 2010 to the year 2018.

The dual/multiple axis trackers on the contrary to the single axis trackers, are designed in smaller capacity structures but mostly on a tall single pole structure which not only increases the capital cost exorbitantly, but also demands prohibitively extra land space—which again increases the cost. In addition, because of the critical and cumbersome single pole design of the dual/multiple axis trackers, the cost of the erection and maintenance also is too high. So, here again, The additional financial benefit generated due to the increase in the productivity achievable owing to the deployment of the dual/multiple axis tracker is not commensurate to the additional cost deployed to install the dual/multiple axis tracker.

As, the trackers available in the market are not economically viable in today's prevailing least cost solar power plant market conditions, there is a dire need for a better ‘solar tracker’, which eliminates the disadvantages of the existing single and dual/multiple axis trackers in the market and be economically viable in today's context, in the prevailing solar power plant cost.

The ‘Integrated Tilting Solar Tracker (ITST)’ in this invention is the perfect solution in today's market situation when the cost of the solar power plant is at the least. In other words, the ‘Integrated Tilting Solar Tracker (ITST)’ in this invention is commercially viable, and at the same time, capable to generate the highest productivity, by an innovative and ‘integrated tilting’ of the solar photovoltaic panels in both East-West and North-South directions simultaneously.

### DISCLOSURE OF THE INVENTION

The principle of construction and design of the ‘Integrated Tilting Solar Tracker (ITST)’ in this invention is based on the ‘integrated tilting’ construction of the ‘Integrated Tilting Solar Tracker (ITST)’ apparatus with unique integrated tilting arrangement for tilting the solar photovoltaic (SPV) panels simultaneously in the ‘East-West’ and ‘North-South’ directions in an ‘integrated manner’, in order to maintain the surface of the solar cells affixed over the solar photovoltaic panels, receive the sun's light rays perpendicularly during most period of the day time (sunny time) of a day and every day in a year, matching the dynamic and varying 3-dimensional movements of the sun with respect to the location of the ‘Integrated Tilting Solar Tracker (ITST)’, to generate maximum solar energy resulting in the highest productivity.

Power generation capability of a solar photo voltaic (SPV) panel will be at its highest (maximum) level, when the angle if incidence of the sun ray is at 90 degrees to the top surface of the solar cells thus mounted on a SPV Panel. So, every ‘solar tracker’ in the market attempts to orient the SPV Panels in such a way to receive the sunray's angle of incidence at 90 degrees for “most of the sunny duration in the day time of a day, and every day of the year to achieve the highest ‘productivity’. Sun moves in a dynamic 3-dimensional path in a day and varying every day in a year. Also, sun's path is different for different location. Hence, the orientation ‘capability’ of the ‘solar tracker’ matters most to increase the ‘capability’ of the power generation. In other words, a ‘solar tracker’ which has the ‘capability’ to dynamically orient the plurality of the solar photovoltaic panels mounted on the solar photovoltaic panels to face the sun's position, in order that the top surface of the solar cells affixed over the solar photovoltaic panels, receive the sun's light rays perpendicularly during most of the period of the day time (sunny time) of a day and every day in a year matching the dynamic position of the sun in a day and varying every day in a year, only can generate maximum solar power.

Fig-19 illustrates sun's motions, as ‘sun path’s (33) (Fig-19) for different important dates in a complete year cycle are plotted for a particular project location (Latitude and Longitude) 34 (Fig-19) on earth for a period of one full year (one cycle). (Fig-20) illustrates the same sun paths in isometric view for better understanding.
1. Any location on the earth is normally denoted by latitude and longitude value of that location. With respect to the point of location on the earth, one can plot the sun's motions for any particular day in a year.
2. Sun's motion is location specific (Sun's motions are different for different locations) and follows a dynamic 3-dimensional path daily with respect to any specific location on earth and varying every day in a year.
3. Fig-19 illustrates the sun's path as seen from the top (plan view) for different dates in one year. Referring the East West line 36 (Fig-19) of the earth, only two days in a year, September 21^{st} and March 21^{st} (A-A1) (Fig-19), the Sun rises exactly at the East and sets exactly in the West for any location.
4. The sun ‘rising’ point on December 21^{st} (G) (Fig-19) is the farthest point in the South East, from the East West line 36 (Fig-19), at which the Sun rises and the sun rising point on June 21^{st} (D) is the farthest point in the North East, from the East West line 36 (Fig-19), at which the Sun rises. Similarly, the sun ‘setting’ point on December 21^{st} (GI) is the farthest point in the South West, from the East West line (36) (Fig-19), at which the Sun ‘sets’ and the sun setting point on June 21^{st} (D1) is the farthest point in the North West, from the East West line 36 (Fig-19), at which the Sun ‘sets’.

In other words, the Sun rises in South-East and sets in the South-West from September 21^{st} (A) (Fig-19) to December 21^{st} (G) (Fig-19) by gradually drifting ‘away’ from the East West line 36 (Fig-19) and from December 21^{st} (G) (Fig-19) to March 21 (A) (Fig-19) by gradually drifting ‘towards’ the East West line 36 (Fig-19).

Likewise, the Sun ‘rises’ in the North-East and ‘sets’ in the North-West from March 21^{st} (A) (Fig-19) to June 21^{st} (D) (Fig-19) by gradually drifting ‘away’ every day, from the East West line (36) (Fig-19) and from June 21^{st} (D) (Fig-19) to March 21^{st} (A) (Fig-19) by gradually drifting ‘towards’ the East West line (36) (Fig-19), every day.

The East-West line is named as Y-Y axis 36 (Fig-19) and the exact North-South line is named as X-X axis 35 (Fig-19).

The actual sun's paths throughout the day time—for those specified dates—as viewed from the top (plan view), is plotted as sun's paths 33 (Fig-19) for a particular location (Lat-Long) on earth 34 (Fig-19) for understanding purpose. Similarly, for different locations, the Sun's paths can be plotted, since Sun's motion is location specific.

The present invention ‘Integrated Tilting Solar Tracker (ITST)’ is innovatively designed and constructed to perform with unique integrated tilting arrangement for tilting the solar photovoltaic (SPV) panels simultaneously in the ‘East-West’ and ‘North-South’ directions in an ‘integrated manner’, in order to maintain the surface of the solar cells affixed over the solar photovoltaic panels, receive the sun's light rays perpendicularly during most period of the day time (sunny time) of a day and every day in a year, matching the dynamic and varying 3-dimensional movements of the sun with respect to the location of the ‘Integrated Tilting Solar Tracker (ITST)’, to generate maximum solar energy resulting in the highest productivity.

Fig-1 and Fig-3 illustrate one row of the twin-frame assembly 5 of the ‘Integrated Tilting Solar Tracker (ITST)’ in this invention. Every row of the twin-frame Integrated Tilting Solar Tracker assembly 5 consists of two single frame assembly 20 (Fig-1) (Fig-3) (Fig-4) designed with ‘modular’ concept with fastener joints (48) (Fig-4).

Each SPV panel 2 (Fig-3) is assembled between two panel mounting frames 24 (Fig-7) kept in parallel and each panel mounting frames 24 (Fig-7) are integral with a part called panel mounting frame holder 25 (Fig-7) (Fig-8). Every SPV panel assembly 23 (Fig-7) is mounted through the twin frame holding provision-1 19 (Fig-4) & the twin frame holding provision-2 21 Fig-4 provisions oppositely located in the single frame assembly 20 (Fig-4).

Each single frame assembly 20 (Fig-1) (Fig-3) is designed to hold 6 solar photo voltaic SPV panel assemblies 23 (Fig-7). A gap (47) (Fig-11) (Fig-3) is maintained between the two successive SPV panel assemblies 23 (Fig-11) to avoid the shadow of the previous SPV panel to fall on the immediate successive SPV panel while tilting in either North or South direction. This gap 47 (Fig-1) also enables the wind to escape, while the wind force acts on the twin frame assembly 5 (Fig-14) when either the twin frame assembly 5 (Fig-15) is at the minimum height of the twin frame assembly 31 (Fig-15) or when the twin frame assembly 5 (Fig-14) is at the maximum height of the twin frame assembly 30 (Fig-14). Such provision of gap 47 (Fig-11) diffuses the excessive wind force and keeps the twin frame assembly safe against the very high speed wind forces.

Each of the solar photo voltaic panel assembly 23 (Fig-17) (Fig-18) as mounted in the single frame assembly 20 (Fig-17) is provided with an exclusive SPV panel tilting gear box 14 (Fig-17) (Fig-18). Each SPV panel tilting gear box 14 (Fig-9) is mounted on the gear box bracket 22 (Fig-4) (Fig-17) to independently tilt each of the solar photo voltaic panel assembly 23 (Fig-17) (Fig-18) in the Y-Y axis 6 (Fig-17) to effect the North-South tilting movements to the extent of 55 degrees on both the North and South directions.

Each single frame assembly 20 (Fig-17), holds 6 SPV panels assemblies 23 (Fig-17). For every single frame assembly 20 (Fig-17) there is ‘one’ SPV Panel assembly tilting Master drive source 16 (Fig-17) (Fig-12) (Fig-9) (Fig-18) which consists of one SPV panel tilting master drive gear box 17 (Fig-17) (Fig-18) (Fig-12) and one SPV panel tilting master drive motor 18 (Fig-17) (Fig-18) (Fig-12) to drive all the 6 SPV Panel tilting gear box 14 (Fig-12) though power transmission shaft 15 (Fig-12) (Fig-17), to effect a simultaneous tilting motions in the Y-Y axis in the North-South directions, to all the 6 SPV panels assemblies 23 (Fig-17) at the same time.

All the 6 SPV Panel gear boxes 14 (Fig-12) and SPV panel tilting master drive gear box 17 (Fig-12) are designed with worm and worm gear boxes for the purpose of very high speed reduction, increased torque and to have self locking requirements to avoid reverse loading of the SPV panel tilting master drive motor 18 (Fig-17) (Fig-18) (Fig-12).

The SPV panel tilting master drive motor 18 (Fig-17) (Fig-18) (Fig-12) fitted with every single frame assembly 20 (Fig-17) is a stepper motor with required torque and speed.

One row of the twin-frame assembly 5 (Fig-1) (Fig-5) is mounted on 1 centre pillar 4 (Fig-1) and 4 side pillars 2 on each side of the centre pillar) 3 (Fig-1). Each centre pillar 4 (Fig-1) (Fig-2) consists of centre pillar civil foundation 12 (Fig-2), extended pillar type-2 13 (Fig-2) and Pivot support pillar assembly-1 (11) (Fig-2). Each side pillar 3 (Fig-1) (Fig-2) consists of centre pillar civil foundation 10 (Fig-2), extended pillar type-2 9 (Fig-2) and Pivot support pillar assembly-1(8) (Fig-2). Hinge pins 7 (Fig-2) are provided at 4 numbers of Pivot support pillar assembly-1(8) (Fig-2) for side pillars and at one number of Pivot support pillar assembly-1(11) (Fig-2) for centre pillar.

The entire twin-frame assembly (5) (Fig-5) (Fig-6) is mounted on the 5 pillars using the hinge pins 7 (Fig-2) at each of the pillars, to enable the twin-frame assembly 5 (Fig-5) (Fig-6) to tilt in the X-X axis (1) (Fig-1) in the East-West direction to the extent of 55 degrees on both the east and west directions.

The tilting of ‘each’ one row of twin-frame assembly 5 (Fig-3) (Fig-4) is effected by using the twin frame tilting arms 26 (Fig-3) (Fig-4) fitted with the each single frame assembly 20 (Fig-4).

The unique concept in this invention is keeping a ‘cluster’ of 26 rows of the twin frame assemblies 5 (Fig-1) (Fig-3) as one ‘table’ 37 (Fig-23) (Fig-22) by keeping the twin frame main drive source 43 (Fig-22) (Fig-23) (Fig-10) at the middle of the 26 rows [equally spaced 40 (Fig-23) 13 rows of twin frame assembly 5 (Fig-22) on either side of ‘one’ Twin frame main drive source 43 (Fig-22) (Fig-23) (Fig-10)] to enable all the 26 rows of the twin frame assemblies 5 (Fig-22) can be tilted ‘together’ in the X-X axis 1 (Fig-1) (Fig-5) in the East and West directions. Each of the ‘table’ 37 (Fig-23) (Fig-22) is driven by ‘one’ Twin frame main drive source 43 (Fig-10) (Fig-22) (Fig-23) which consists of ‘one’ Twin frame main drive motor 45 (Fig-10) (Fig-22), ‘one’ twin frame main drive reduction gear box 46 (Fig-10) (Fig-53) and ‘one’ twin frame main drive gearbox 42 (Fig-10). The output shaft of the twin frame main drive gearbox 42 (Fig-10) is fitted with ‘one’ Twin frame main drive lever 32 (Fig-10). Each of the 13 twin frame tilting arms 26 (Fig-3) (Fig-4) pertaining to 13 rows of the twin frame assemblies 5 (Fig-22), located at either side of the twin frame main drive source 43 (Fig-10) (Fig-22) (Fig-23), are inter connected through a twin frame row connector 38 (Fig-22) (Fig-23) and twin frame Main drive source connector 44 (Fig-22) (Fig-23) (Fig-10) to the Twin frame main drive lever 32 (Fig-10).

So, whenever, the twin frame main drive source 43 (Fig-10) (Fig-22) (Fig-23) rotates, the Twin frame main drive lever 32 (Fig-10) tilts either clockwise or anti-clockwise depending upon the rotational direction of the twin frame main drive source 43 (Fig-10) (Fig-22) (Fig-23) and the tilting motion of the Twin frame main drive lever 32 (Fig-10) is transmitted to the frame Main drive source connector 44 (Fig-22) (Fig-23) (Fig-10) and twin frame row connectors 38 (Fig-22) (Fig-23), thus effecting a tilting motion to all the 26 rows of the twin frame assemblies 5 (Fig-22) ‘together’ simultaneously and at the same time.

All the Twin frame main drive gearbox 42 (Fig-10) and the Twin frame main drive reduction gear box 46 (Fig-10) are designed with worm and worm gear boxes for the purpose of very high speed reduction, increased torque and to have natural self locking requirements to avoid reverse loading of the Twin frame main drive reduction gear box 46 (Fig-10).

The ‘sole’ twin frame main drive motor 45 (Fig-10) fitted with the twin frame main drive reduction gear box 46 (Fig-10) is a stepper motor with required torque and speed.

A group of 10 tables 37 (Fig-24) make 1 MW capacity 41 (Fig-24).

The grouping of tables 37 (Fig-24) to aggregate any capacity and to get accommodated any shape of the land is the distinct advantage of this invention.

Each SPV Panel assembly tilting Master drive source 16 (Fig-17) (Fig-12) (Fig-9) is electronically driven by a separate ‘driver-1’ which is controlled by a ‘controller-1’ (Fig-21).

Similarly, Each Twin frame main drive source 43 (Fig-10) (Fig-22) (Fig-23) is electronically driven by a separate ‘driver-2’ which is controlled by a ‘controller-2’ (Fig-21).

Group of ‘controller-1’ are controlled by a master ‘controller-master-1’ (Fig-21).

Similarly, the group of ‘controller-2’ are controlled by a master ‘controller-master-2’ (Fig-21).

The software in the ‘controller-master-1 (Fig-21) and ‘controller-master-2’ (Fig-21) are fed with a custom developed programme to operate both the east-west and north-south tilting in an ‘integrated manner’ to dynamically orient the solar photovoltaic panels mounted on the ‘Integrated Tilting Solar Tracker (ITST)’ apparatus with unique integrated tilting arrangement for tilting the solar photovoltaic (SPV) panels simultaneously in the ‘East-West’ and ‘North-South’ directions in an ‘integrated manner’, in order to maintain the surface of the solar cells affixed over the solar photovoltaic panels, receive the sun's light rays perpendicularly during most period of the day time (sunny time) of a day and every day in a year, matching the dynamic and varying 3-dimensional movements of the sun with respect to the location of the ‘Integrated Tilting Solar Tracker (ITST)’, to generate maximum solar energy resulting in the highest productivity.

The arrangement of the SPV Panel assembly tilting Master drive source 16 (Fig-17) (Fig-12) (Fig-9) and the 6 numbers of SPV panel tilting gear box 14 (Fig-17) (Fig-18) sets are in the opposite portion of the twin-frame assembly 5 (Fig-16) to have static balancing of the one row of the twin frame assembly 5 (Fig-16) to minimise the torque requirement to tilt the twin-frame assembly and the twin frame assembly cluster 5 (Fig-22).

The unique design of the ‘Integrated Tilting Solar Tracker (ITST)’ apparatus is in such a way to maintain the minimum height 31 (Fig-15) at the ‘home’ position for the twin-frame assembly 5 (Fig-16) from the ground. This is an exclusive feature, since this arrangement helps in two ways: (a) the erection and commissioning of the ‘Integrated Tilting Soar Tracker (ITST)’ can be done by a person just by standing on the ground. No crane, ladder is required. (b) Since the height of the ‘home’ position is very low, the maintenance of the SPV Panels on the twin-frame assembly 5 (Fig-16) of the ‘Integrated Tilting Solar Tracker (ITST)’ either for cleaning or for wiring can be done with ease and faster, even when the twin frame assembly is in the maximum tilted position 30 (Fig-14).

Fig-13 illustrates the design of the ‘Integrated Tilting Solar Tracker (ITST)’ apparatus indicating the Maximum south position 27 (Fig-13), Minimum south position 28 (Fig-13) and Maximum north position 29 (Fig-13).

Fig-23 illustrates the design of the ‘Integrated Tilting Solar Tracker (ITST)’ apparatus with a Saw tooth design 39 (Fig-23). This is a very special design which enables the wind force to escape between the two rows of the twin-frame assembly 5 (Fig-16) (Fig-23) to minimise the risks related to wind force acting on the table 37 (Fig-22) (Fig-23).

Fig-23 also illustrates the design of the ‘Integrated Tilting Solar Tracker (ITST)’ apparatus with equal ‘space or distance’ between rows 40 (Fig-23) to avoid the falling of shadow of the previous row of the twin-frame assembly 5 (Fig-16) (Fig-23) over the successive twin-frame assembly 5 (Fig-16) (Fig-23) when they are clustered as one table 37 (Fig-22) while tilting of the twin frame assembly in either of east or west directions to the extent of 55 degrees.

Backtracking is also provided in the operation of tilting of the twin frame assembly 5 (Fig-1) (Fig-22) to avoid the shadow of the previous row of the twin-frame assembly 5 (Fig-16) (Fig-23) over the successive twin-frame assembly 5 (Fig-16) (Fig-23) when they are clustered as one table 37 (Fig-22) while tilting of the twin frame assembly in either of east or west directions during the dawn and dusk periods of the sun.

Additional tables 37 can be grouped with every table 37 (Fig-24) in all the four sides to augment the capacity to form a higher capacity solar power plant 41 (Fig-24).

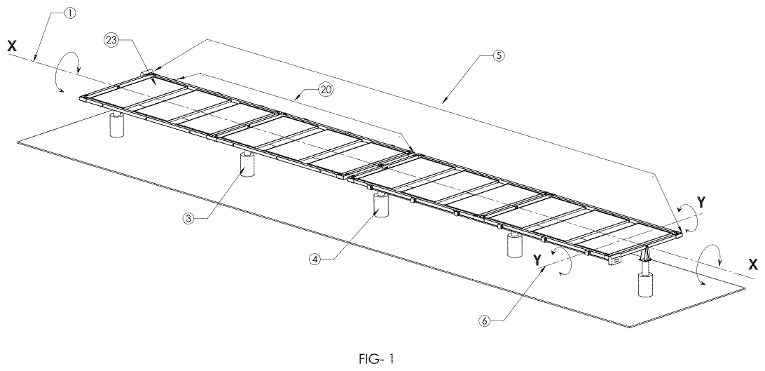

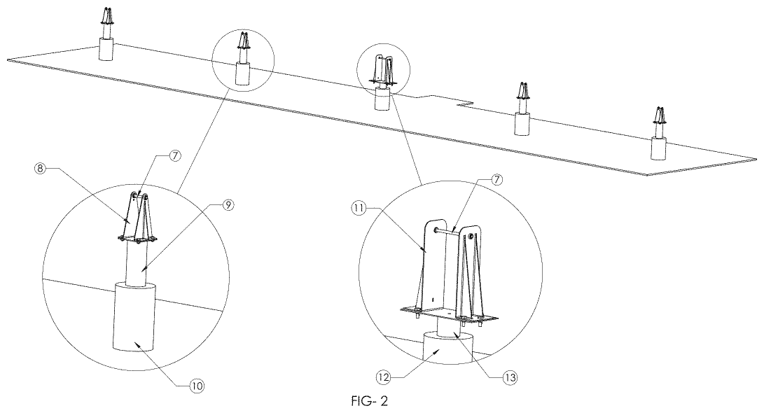

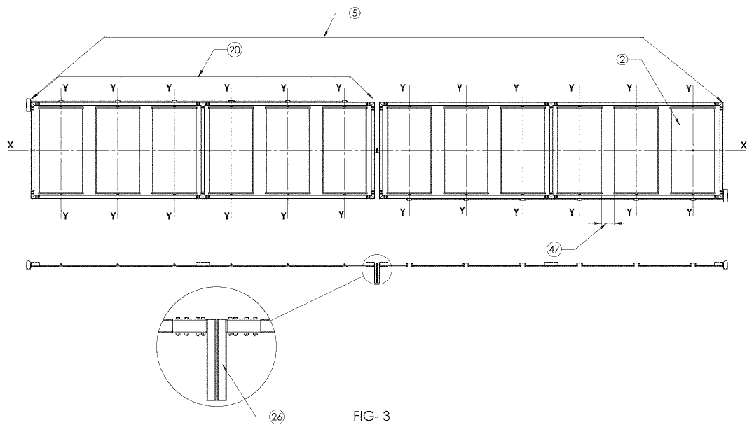

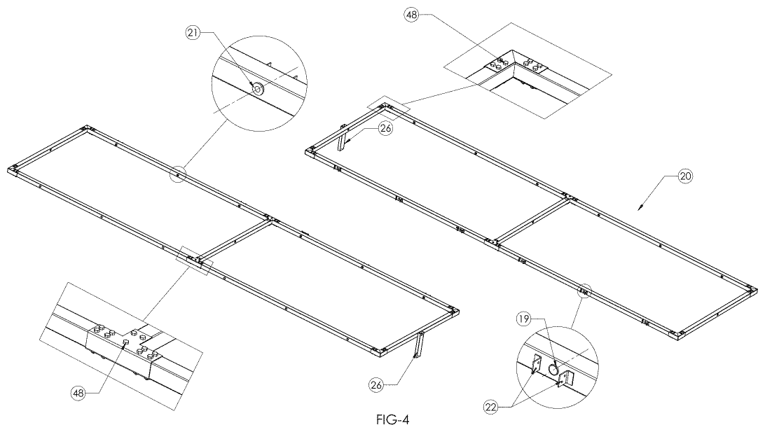

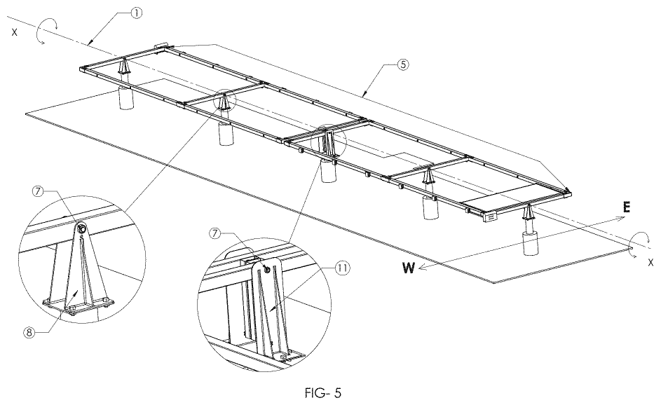

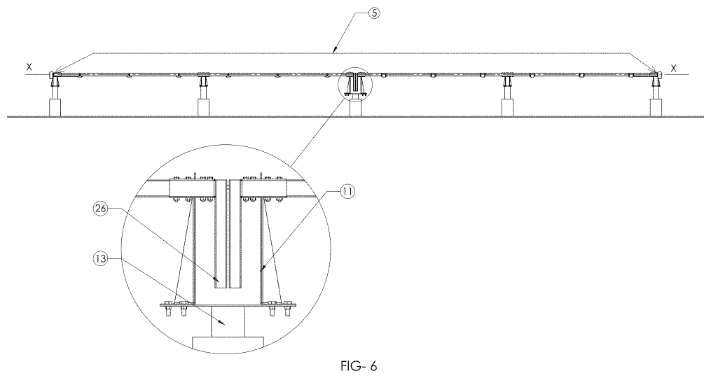

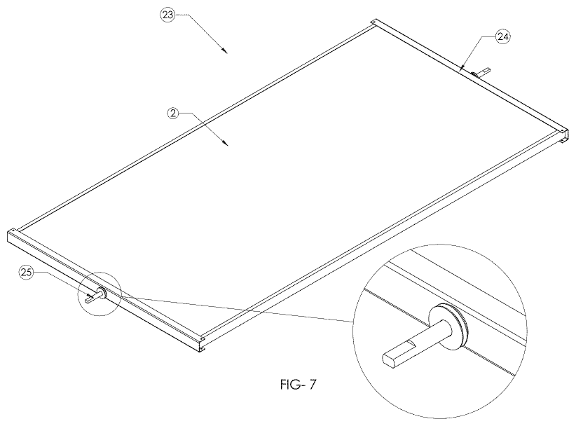

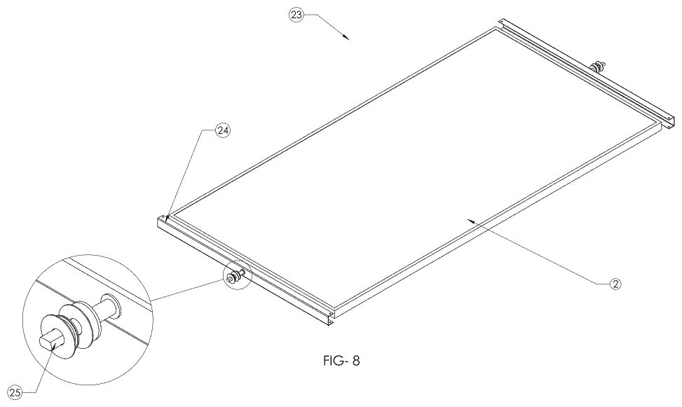

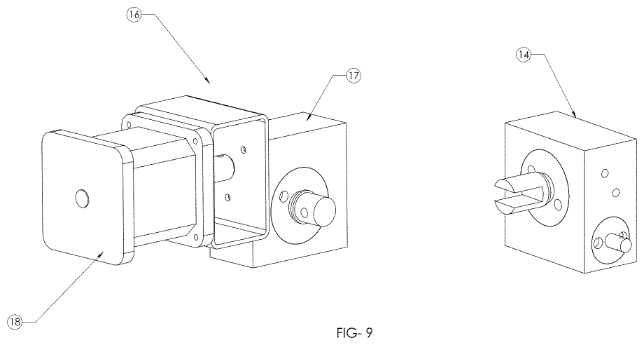

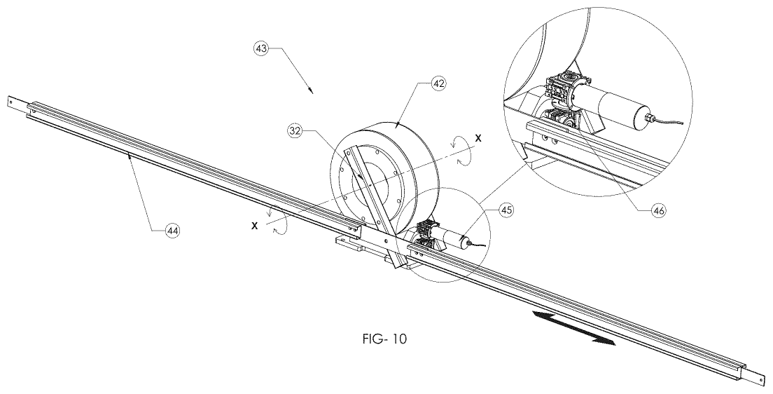

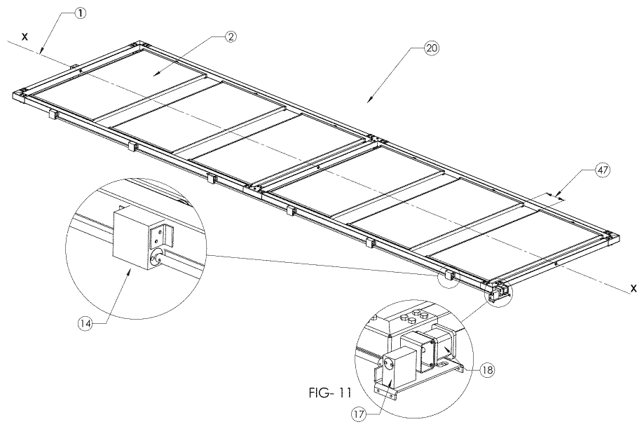

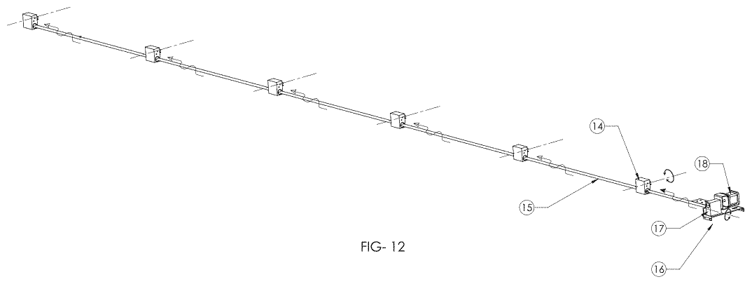

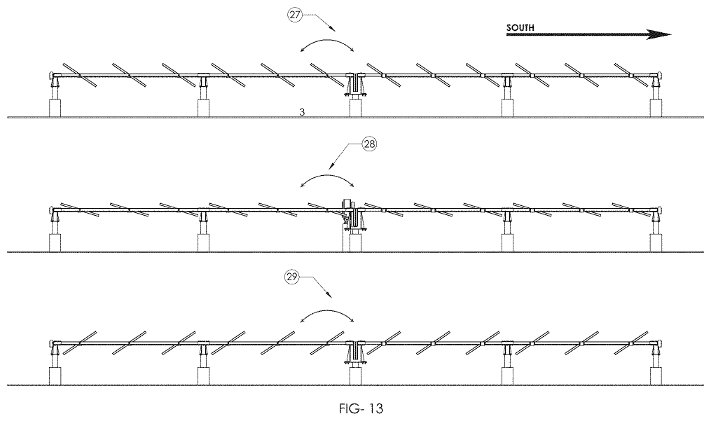

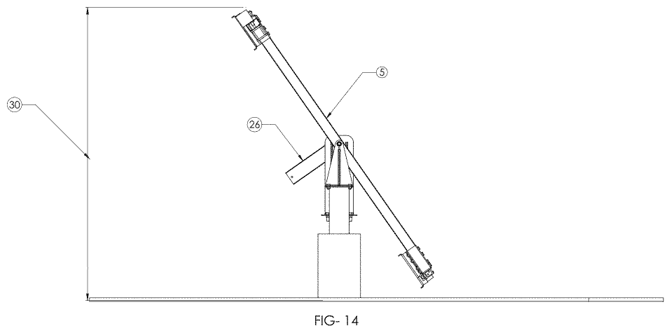

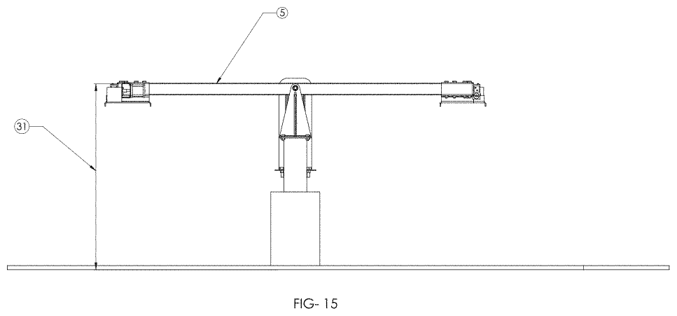

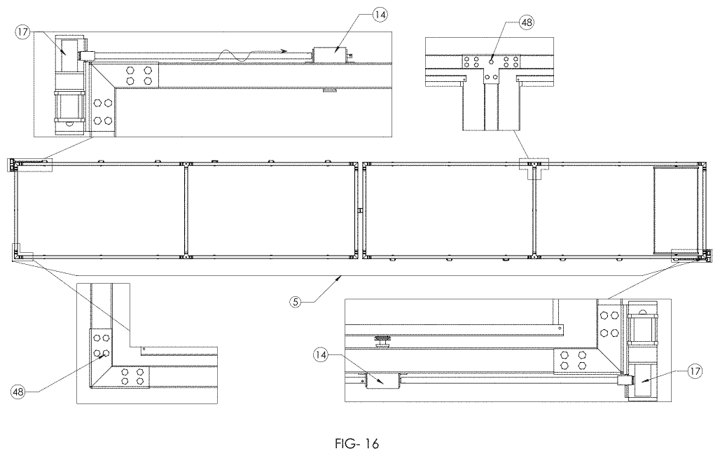

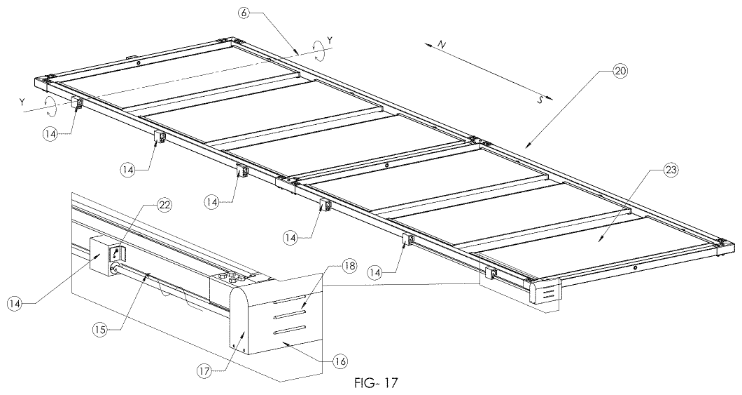

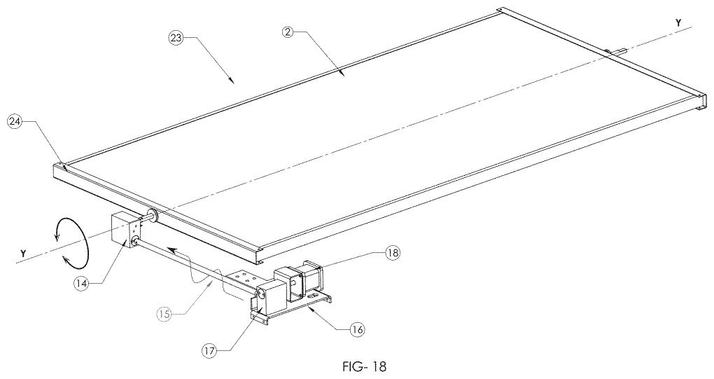

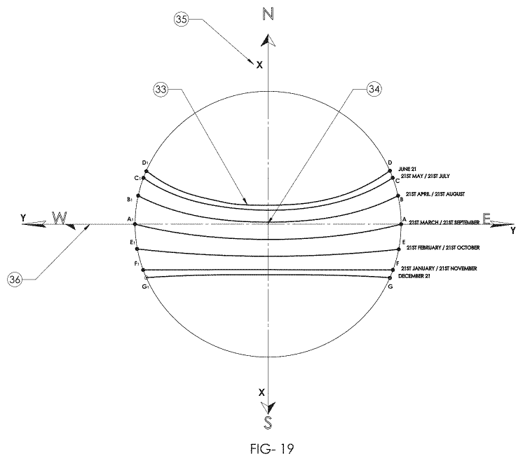

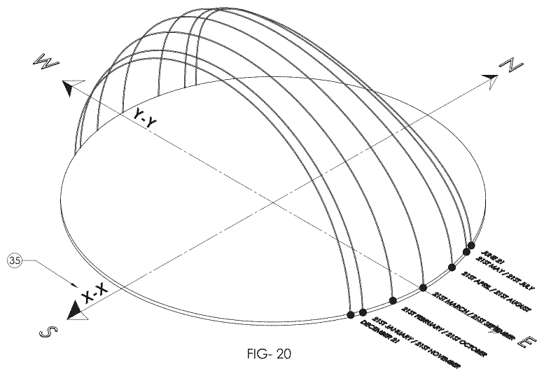

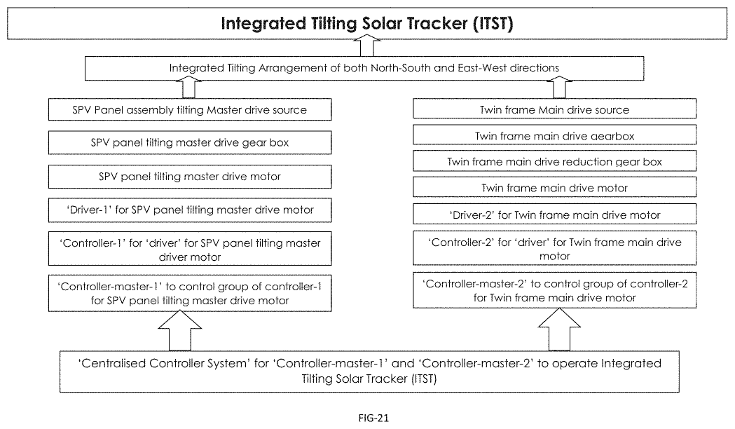

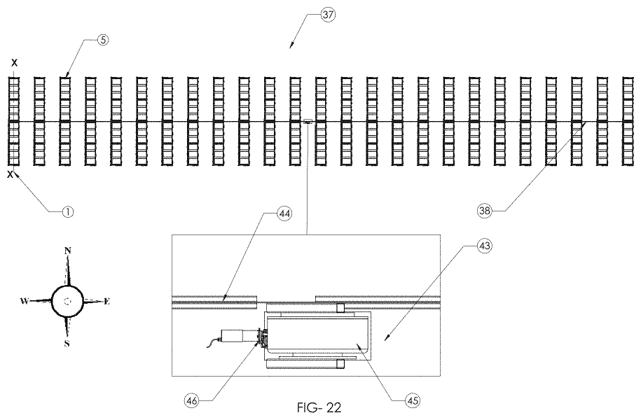

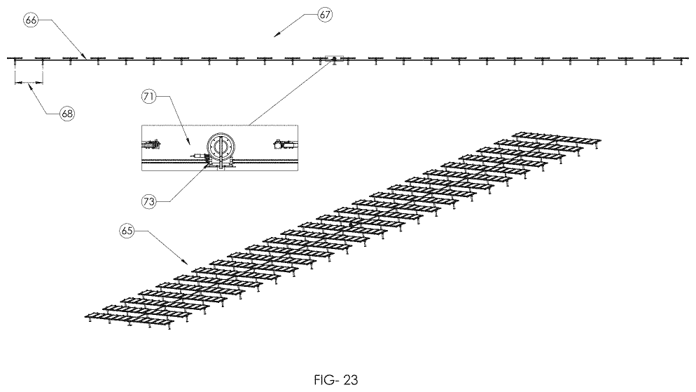

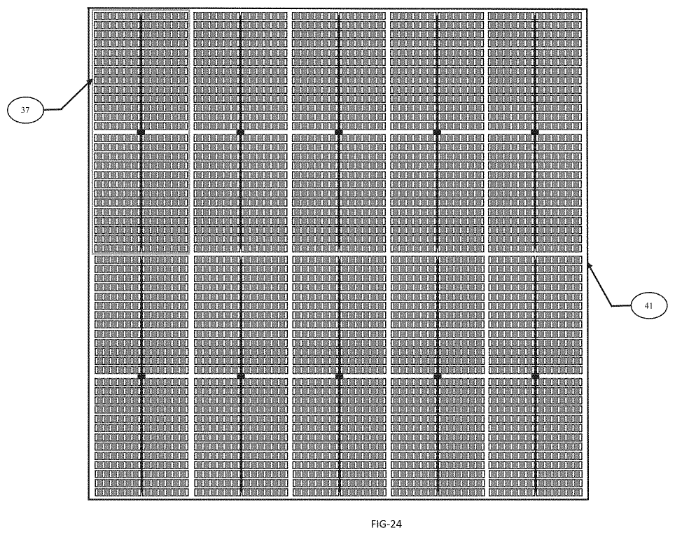

### BRIEF DESCRIPTION OF THE DRAWINGS

| | Drawing | |
|---|---|---|
| S. No | Number | Description |
| 1 | FIG. 1 | ISOMETRIC View of the twin frame |
| | | assembly with SPV panel |
| | | asemblies mounted |
| 2 | FIG. 2 | ISOMETRIC View of the two single |
| | | frame assembly indicating |
| | | the fastener joints and gear mounting brackets |
| 3 | FIG. 3 | Top and Eleveation view of |
| | | the twin frame assembly with all |
| | | the SPV Panel assemblies assembled |
| 4 | FIG. 4 | ISOMETRIC View of the 5 pillars |
| | | and the construction |
| 5 | FIG. 5 | ISOMETRIC View of the twin |
| | | frame assembly as mounted on |
| | | the 5 pillars |
| 6 | FIG. 6 | ISOMETRIC View of the |
| | | SPV Panel assembly |
| 7 | FIG. 7 | ELEVATION View of the twin |
| | | frame assembly as mounted on |
| | | the 5 pillars |
| 8 | FIG. 8 | ISOMETRIC View of the |
| | | SPV Panel assembly with panel |
| | | mounting frame holders |
| 9 | FIG. 9 | ISOMETRIC View of the |
| | | SPV Panel assembly tilting Master |
| | | drive source and the |
| | | panel tilting gear box |
| 10 | FIG. 10 | ISOMETRIC View of the Twin |
| | | frame main drive source |
| 11 | FIG. 11 | ISOMETRIC View of the single frame |
| | | assembly mounted with |
| | | SPV panel assemblies |
| 12 | FIG. 12 | ISOMETRIC View of the |
| | | SPV Panel assembly tilting Master |
| | | drive source and the panel tilting |
| | | gear boxes in an assembled |
| | | condition |
| 13 | FIG. 13 | Elevation view of the twin frame |
| | | assembly as mounted on the 5 |
| | | pillars with various tilting postions |
| | | of the SPV Panels as mounted |
| 14 | FIG. 14 | View of the tracker, when the twin |
| | | frame is at 55 degrees tilt |
| 15 | FIG. 15 | View of the tracker, when the twin |
| | | frame is at the horizontal position. |
| 16 | FIG. 16 | view of the twin frame assembly |
| | | indicating the SPV panel |
| | | tilting master drive gear boxes |
| | | mounted on the opposite corners |
| 17 | FIG. 17 | View of the single frame assembly |
| | | with SPV Panels assembly mounted |
| 18 | FIG. 18 | view of the SPV panel assembly with |
| | | SPV panel tilting master |
| | | drive gear boxe arrangement |
| 19 | FIG. 19 | TOP View of the sun paths for |
| | | different important dates in a |
| | | complete year duration (one cycle) |
| 20 | FIG. 20 | ISOMETRIC View of the sun |
| | | paths for different important |
| | | dates in a complete year |
| | | duration (one cycle) |
| 21 | FIG. 21 | View of the flow diagram indicating |
| | | the drive systems, drivers, |
| | | controllers etc, |
| 22 | FIG. 22 | TOP VIEW of one table assembly |
| | | with Twin frame main drive source |
| 23 | FIG. 23 | ISOMETRIC and ELEVATION |
| | | VIEW of one table assembly |
| | | with Twin frame main drive source |
| 24 | FIG. 24 | Schematic view of the cluster |
| | | of tables to form 1 MW solar |
| | | power plant |

‘INTEGRATED TILTING SOLAR TRACKER (ITST)’ APPARATUS can be observed therein comprising the parts indicated below:

| PART | |
|---|---|
| No. | PART NAME |
| 1 | Axis of rotation in East-West direction (X-X Axis) |
| 2 | Solar Photo Voltaic Panel |
| 3 | Side Pillar |
| 4 | Centre Pillar |
| 5 | One row of twin frame assembly |
| 6 | Axis of rotation in North-South direction (Y-Y Axis) |
| 7 | Hinge pin |
| 8 | Pivot support pillar assembly - 2 |
| 9 | Extended pillar type-1 |
| 10 | Side pillar civil foundation |
| 11 | Pivot support pillar assembly -1 |
| 12 | Centre pillar civil foundation |
| 13 | Extended pillar type -2 |
| 14 | SPV Panel tilting gear box |
| 15 | Power transmission shaft |
| 16 | SPV Panel assembly tilting Master drive source |
| 17 | SPV panel tilting master drive gear box |
| 18 | SPV panel tilting master drive motor |
| 19 | Twin frame holding provision -1 for SPV panel assembly |
| 20 | Single frame assembly |
| 21 | Twin frame holding provision -2 for SPV panel assembly |
| 22 | Gear box bracket |
| 23 | SPV panel assembly |
| 24 | Panel mounting frame |
| 25 | Panel mounting frame holder |
| 26 | Twin frame tilting arm |
| 27 | Maximum south position |
| 28 | Minimum south position |
| 29 | Maximum north position |
| 30 | Maximum height of the twin frame |
| 31 | Minimum height of the twin frame assembly |
| 32 | Twin frame main drive lever |
| 33 | Sun path |
| 34 | Project location (Lat-Long) |
| 35 | North South Line X-X axis |
| 36 | East West line Y-Y axis |
| 37 | Table |
| 38 | Twin Frame row connector |
| 39 | Saw tooth design |
| 40 | Space or Distance between rows |
| 41 | Group of 10 tables to make 1 MW capacity |
| 42 | Twin frame main drive gearbox |
| 43 | Twin frame main drive source |
| 44 | Twin frame Main drive source connector |
| 45 | Twin frame main drive motor |
| 46 | Twin frame main drive reduction gear box |
| 47 | Gap between the two successive SPV panel assemblies |
| 48 | Fastener joints |

I claim:

1. ‘Integrated Tilting Solar Tracker (ITST)’ comprises of one row of the twin-frame assembly 5 (Fig-1). Every row of the twin-frame Integrated Tilting Solar Tracker assembly 5 consists of two single frame assembly 20 (Fig-4) designed with ‘modular’ concept with fastener joints 48 (Fig-4). Each Solar Photovoltaic Panel 2 (Fig-7) is assembled between two parallel panel mounting frames 24 (Fig-7). Every SPV panel assembly 23 (Fig-7) is mounted through the twin frame holding provision-1 (19) (Fig-4) & the twin frame holding provision-2 (21) (Fig-4) provisions located oppositely in the single frame assembly 20 (Fig-4).
Each single frame assembly 20 (Fig-1) (Fig-3) is designed to hold 6 solar photo voltaic SPV panel assemblies 23 (Fig-7). Each of the solar photo voltaic panel assembly 23 (Fig-17) (Fig-18) as mounted in the single frame assembly 20 (Fig-17) is provided with an exclusive SPV panel tilting gear box 14 (Fig-17) (Fig-18) to independently tilt the solar photo voltaic panel assembly 23 (Fig-17) (Fig-18) in the Y-Y axis 6 (Fig-17) and is powered by ‘one’ SPV Panel assembly tilting Master drive source 16 (Fig-17) (Fig-12) (Fig-9) (Fig-18) which consists of SPV panel tilting master drive gear box 17 (Fig-17) (Fig-18) (Fig-12) and SPV panel tilting master drive motor 18 (Fig-17) (Fig-18) (Fig-12) to drive all the 6 SPV Panel tilting gear box 14 (Fig-12) together through power transmission shaft 15 (Fig-12) (Fig-17), to effect a simultaneous tilting motions in the Y-Y axis 6 (Fig-17).
The entire twin-frame assembly 5 (Fig-5) (Fig-6) is mounted on the 5 pillars to tilt in the X-X axis 1 (Fig-1). The tilting of ‘each’ one row of twin-frame assembly 5 (Fig-3) (Fig-4) is effected through tilting the twin frame tilting arms 26 (Fig-3) (Fig-4) fitted with the each single frame assembly 20 (Fig-4). A ‘cluster’ of 26 rows of the twin frame assemblies 5 (Fig-1) (Fig-3) as one ‘table’ 37 (Fig-23) (Fig-22) by keeping the twin frame main drive source (43) (Fig-22) (Fig-23) (Fig-10) at the middle of the 26 rows [equally spaced 40 (Fig-23) 13 rows of twin frame assembly 5 (Fig-22) on either side of ‘one’ Twin frame main drive source 43 (Fig-22) (Fig-23) (Fig-10)] to enable all the 26 rows of the twin frame assemblies 5 (Fig-22) can be tilted ‘together’ in the X-X axis 1 (Fig-1) (Fig-5) in East and West directions. It is designed to constitute 1 MW by a group of 10 tables 48 (Fig-24).
Both the SPV Panel assembly tilting Master drive source 16 (Fig-17) (Fig-12) (Fig-9) and frame main drive source 50 (Fig-10) (Fig-22) (Fig-23) are electronically driven by a separate ‘drivers’ and ‘controllers’, which are fed with a programmed software to operate for tilting the solar photovoltaic (SPV) panels simultaneously in the ‘East-West’ and ‘North-South’ directions in an ‘integrated manner’, in order to maintain the surface of the solar cells affixed over the solar photovoltaic panels, receive the sun's light rays perpendicularly during most period of the day time (sunny time) of a day and every day in a year, matching the dynamic and varying 3-dimensional movements of the sun with respect to the location of the ‘Integrated Tilting Solar Tracker (ITST)’, to generate maximum solar energy resulting in the highest productivity.

2. The ‘Integrated Tilting Solar Tracker (ITST)’ apparatus according to claim 1, is an innovative modular type design, with every row of the twin-frame Integrated Tilting Solar Tracker assembly 5 consists of two single frame assembly 20 (Fig-4) designed with ‘modular’ concept with fastener joints 48 (Fig-4).

3. The ‘Integrated Tilting Solar Tracker (ITST)’ apparatus according to claim 1, wherein, each Solar Photo Voltaic panel 2 is uniquely held between two parallel panel mounting frames 24 (Fig-7) and each panel mounting frames 24 are integral with a part called panel mounting frame holder 25 (Fig-7) (Fig-8) and every SPV panel assembly 23 (Fig-7) is mounted through the twin frame holding provision-1 (19) (Fig-4) & the twin frame holding provision-2 (21) (Fig-4) provisions located oppositely in the single frame assembly 20 (Fig-1)(Fig-3).

4. The ‘Integrated Tilting Solar Tracker (ITST)’ apparatus according to claim 1, wherein, all the ‘Integrated Tilting Solar Tracker (ITST)’ are modular and parts are with Ready-To-Assemble (RTA) system in construction and are factory manufactured.

5. The ‘Integrated Tilting Solar Tracker (ITST)’ apparatus according to claim 1, wherein, the concept of construction of twin frame assembly 5 (Fig-1) for each row and the concept of cluster construction for each table 37 (Fig-22) (Fig-23) (Fig-24) are modular and expandable to customize to any capacity requirement.

6. The ‘Integrated Tilting Solar Tracker (ITST)’ apparatus according to claim 1, wherein, the table 37 (Fig-22) construction of Integrated Tilting Solar Tracker (ITST) can be installed in any shape of the land.

7. The ‘Integrated Tilting Solar Tracker (ITST)’ apparatus according to claim 1, wherein, the Integrated Tilting Solar Tracker (ITST) structure has in-built open C-conduit (38) (44) (Fig-22) (Fig-23) (Fig-10) for multipurpose applications to accommodate routing of the various power and communication cables added with provisions for accommodating the auxiliary items of solar power plant like, array junction boxes, string inverters, lightening arresters, earthing points.

8. The ‘Integrated Tilting Solar Tracker (ITST)’ apparatus according to claim 1, wherein, the Integrated Tilting Solar Tracker (ITST) structure is with saw tooth design 39 (Fig-23) to allow the wind to escape through the gaps maintained between the two consecutive rows, thus diffusing the wind forces to the greater extent, resulting in sturdiness and stability of the structure.

9. The ‘Integrated Tilting Solar Tracker (ITST)’ apparatus according to claim 1, wherein, both the SPV Panel assembly tilting Master drive source 16 (Fig-17) (Fig-12) (Fig-9) and frame main drive source 43 (Fig-10) (Fig-22) (Fig-23) are electronically driven by a separate motors, drivers and controllers.

10. The ‘Integrated Tilting Solar Tracker (ITST)’ apparatus according to claim 1, wherein, both the SPV Panel assembly tilting Master drive source 16 (Fig-17) (Fig-12) (Fig-9) and frame main drive source 43 (Fig-10) (Fig-22) (Fig-23) are centrally controlled and operated automatically by a software fed in to the controller-master-1 (Fig-21) and ‘controller-master-2’ (Fig-21) are to operate both the east-west and north-south tilting in an integrated manner.
